(19) United States
(12) Patent Application Publication
(10) Pub. No.: US 2007/0270124 A1
(43) Pub. Date: Nov. 22, 2007

(54) Systems and methods for adding credit to a wireless telecommunications account

(75) Inventors: Nils A. Johnson, New York, NY (US); Rimon Erez, New York, NY (US)

Correspondence Address: TROUTMAN SANDERS LLP, 600 PEACHTREE STREET , NE, ATLANTA, GA, 30308, US

(73) Assignee: ASIATONE LLC, D/B/A GORILLA MOBILE, New York, NY (US)

(21) Appl. No.: 11/437,473

(22) Filed: May 19, 2006

(51) Int. Cl. H04M 11/00

(52) U.S. Cl. 455/406

(57) ABSTRACT

Systems and methods for adding credit to a wireless telecommunications account. A financial transaction system may receive a request for a wireless telecommunication credit transfer. This request may come from any entity desiring the transfer wireless telecommunication credit. The financial transaction system may also receive, from the funding user, an authorization of the request to transfer wireless telecommunication credit. Upon receipt of an authorization from the funding user, the financial transaction system charges the funding user for the wireless telecommunication credit and transfers a wireless telecommunication credit to the wireless telecommunication account of the recipient.

### FIELD OF THE INVENTION

The present invention relates generally to the field of wireless telecommunications systems and specifically to systems and methods for financial transactions in a wireless telecommunications system.

### BACKGROUND

The proliferation of the wireless telecommunications into every sector of business and all facets of personal life and daily activity have far exceeded any initial projections. Wireless communication has become a staple for conducting business in many industries and represents a significant portion of all telecommunications. The coverage areas provided by wireless telecommunication networks across the globe are growing at an exponential rate. In many areas of the world, you are more likely to find wireless communication coverage than LAN based services.

As wireless communication, and the devices which enable it, become more widely integrated into everyday activities, the applications offered by wireless communication service providers greatly expand. The rapid expansion of available services has been made possible in part by the advancements made in the wireless telecommunication technology. Wireless telecommunications technology has progressed from unsecure and low density frequency division multiplexing analog based cellular networks to more secure and higher density cellular networks based on Code Division Multiple Access (CDMA) or Time Division Multiple Access (TDMA) architectures. The most prolific of modern cellular network architectures is the Global System for Wireless communication (GSM) network. The GSM network is a TDMA based system which transmits digital coded data encrypted for secure transmission. GSM networks can provide data networking services to users through the use of the General Packet Radio Service (GPRS). GPRS uses certain channels in the GSM TDMA structure to transmit and receive data. GSM is the popular standard for wireless communications in the world because its networks provide secures services such as data networking, facsimile services, and Short Message Service (SMS).

Short Message Service (SMS) is a functionality available on GSM networks that allows users of the GSM network to send and receive text messages from their wireless device. A wireless network user can enter an SMS message in the user's wireless device and this message is transmitted over the wireless network to the Short Message Service Centre (SMSC). The SMSC is responsible for processing the SMS message, determining its intended destination, and routing the SMS message appropriately. SMS messages are typically limited to 160 characters to permit short bursts of data to be easily handled by the network without incurring significant delays or load on the network. SMS is widely used for such features as sending small messages, wireless chatting, receiving information services like weather, news and entertainment, paging and alert services, network administration, and downloading data and information such as ring tones.

In recent years, the popularity of SMS message communication has increased tremendously. Millions of SMS messages a month are now sent to and between wireless network users. The popularity of SMS messaging has grown especially fast in certain regions of the world and in certain countries. For instance, SMS messaging has become extraordinarily popular in South-East Asia and Europe. SMS messaging enables users of wireless devices to quickly and effectively communicate with others both inside and outside the network of their wireless service provider. As the popularity of SMS messaging increases, so do the services available to the wireless subscribers that use SMS messaging. For example, wireless subscribers have the capability of purchasing products such as ring tones, music downloads, and data downloads via an SMS message request.

As the demand for wireless devices and the services enabled by them increases, so does the demand for credit with a wireless subscriber's service provider to pay for these services. Wireless subscribers can use credit with their wireless service provider to pay for communication via the wireless network, and they can also use their credit to purchase other products and services.

A significant portion of wireless subscribers around the world have an account with their wireless service provider that is structured as a prepaid or stored value account. In fact, the percentage of wireless subscribers using prepaid accounts in some countries or regions far outnumbers the percentage of wireless subscribers with a billed payment account. Prepaid wireless service has achieved significant market penetration in many countries because of its ease of use, convenience, and the minimal risk assigned to both the wireless subscriber and the wireless service provider. In many regions, prepaid wireless service is the only type of service available to consumers. Many wireless service providers allow their prepaid customers to use the stored value in their accounts for minutes of talk time and to pay for services and products made available by the wireless service provider.

Prepaid wireless service is advantageous for both the wireless telecommunications service provider and the wireless subscriber. The wireless subscriber does not have to establish the credit necessary to receive a wireless telecommunication account, and the wireless telecommunications service provider does not have to bear the risk of extending credit. This is especially advantageous in many areas in regions where wireless subscribers are less likely to have the means necessary to carry credit with a wireless telecommunications service provider. Additionally, these wireless subscribers are more likely to not have sufficient resources to pay for the necessary prepaid minutes on their account. Thus, these wireless subscribers are in need of method by which to request and receive credit to their prepaid accounts.

A demand exists in the marketplace for a system or method that permits efficient and effective transfers of credit into a wireless subscriber's account. Conventionally, systems are available that allow wireless subscribers to transfer funds between independent bank accounts of registered with independent financial transaction service providers. While suitable for their intended purposes, these methods of transfer require both of the transacting parties to posses numerous accounts, including a bank account. Furthermore, this conventional method of transfer is very cumbersome and costly to the users. It requires the users to setup accounts with a financial transaction services provider that will enable the transfer, and requires the users to register their bank accounts with these financial transaction service providers. The financial service providers are independent of the wireless service providers, thus a user must have a valid financial service provider account, bank account, and wireless telecommunication account in order to complete a financial transfer. Additionally, the bank accounts must be registered and verified before any transaction can take place. Such pre-registration most often requires access to a computer connected to the Internet. If an individual does not have access to a computer connected to the Internet, then that individual is unable to use the service. Users encounter significant burdens in setting up accounts with all of the necessary entities and ensuring proper integration between all the accounts. Additionally, the user must monitor and manage these accounts to ensure that the financial transactions that take place are verified and accurate. Furthermore, transfers are limited to the inner network of users who registered and verified as active accounts within the network.

Therefore a need exists for a system or method that will enable users of a wireless network to effectively and efficiently transfer and receive credit to a wireless telecommunications account. Furthermore, the ability to transfer credit or funds to wireless telecommunication accounts across the globe is highly desired.

Additionally, the ability to transfer credit without a significant burden to the transacting parties due to pre-registration, administration, and transaction requirements is also highly desired. A system or method is desired that would permit the transfer of credit to a wireless telecommunication account with minimal pre-registration and minimal transaction requirements.

The desired systems and methods to implement such a system are preferably adaptable, modifiable, and robust in order to accommodate for the wide variety of protocols, architectures, and implementations that exist in wireless networks. Financial transactions over a wireless communication link may be complicated and involve the execution and merger of a variety of different functions. Thus, in addition to the ability to communicate across a broad spectrum of network protocols, the desired systems and methods are preferably enabled to execute a variety of different functionality, such as financial, regulatory, communicative, and data management functionality.

### BRIEF SUMMARY OF THE INVENTION

The present invention provides a system and method for adding credit to a wireless telecommunication account. In accordance with one embodiment of the present invention, the financial transaction system provides a novel and effective method for adding credit to a wireless telecommunication account. The financial transaction system has a communication link, a communication system for transmitting a request to transfer a wireless telecommunication credit to a recipient via the communication link, and a processing system interfaced to the communication system for processing the request to transfer a wireless telecommunication credit to a recipient. Additionally, the financial transaction system has a database for storing the request to transfer a wireless telecommunication credit to a recipient. The communication system receives the request to transfer the wireless telecommunication credit via the at least one communication link, transmits the request to the processing system. The processing system processes the request, and instructs the communication system to execute the request. Then, the communication system communicates with a financial institution via the communication link to charge a financial account of the funding user with the financial institution for the amount of the wireless telecommunication credit. Finally, the communication system transmits the wireless telecommunication credit to the wireless telecommunications account of the recipient via the communication link.

Additionally, in accordance with another embodiment of the present invention, a method is provided for adding credit to a wireless telecommunications account. The method involves receiving a request for the transfer of a wireless telecommunication credit to a recipient and processing the request for the transfer of the wireless telecommunication credit. Furthermore, the method requires receiving an authorization to transfer the wireless telecommunication credit from a funding user, charging the funding user for the wireless telecommunication credit to be transferred, and transferring the wireless telecommunication credit to the wireless telecommunications account of the recipient.

These and other features as well as advantages, which characterize the various preferred embodiments of present invention, will be apparent from a reading of the following detailed description and a review of the associated drawings.

### BRIEF DESCRIPTION OF THE DRAWINGS

FIG. 1 provides a high level diagram of an exemplary network in which a system for adding credit to a wireless telecommunication account is implemented in accordance with one embodiment of the present invention;

FIG. 2 provides a flow chart illustrating a method of adding credit to a wireless telecommunication account in accordance with an exemplary embodiment of the present invention;

FIG. 3 is a block diagram illustrating the architecture of certain components within the financial transaction system in accordance with an exemplary embodiment of the present invention;

FIG. 4 is a flow chart an illustrating a financial transaction protocol in an exemplary embodiment of the present invention;

FIG. 5 is a flow diagram illustrating a financial transaction protocol from the funding user's perspective in accordance with in an exemplary embodiment of the present invention;

FIG. 6 is a flow diagram illustrating a financial transaction protocol in an exemplary embodiment of the present invention;

FIG. 7 is a flow diagram illustrating another financial transaction protocol in accordance with an exemplary embodiment of the present invention; and

FIG. 8 is a diagram illustrating of an implementation of the financial transaction system in accordance with one embodiment of the present invention.

### DETAILED DESCRIPTION

The present invention addresses the deficiencies in the prior art by providing a financial transaction system or and a financial transaction method for adding wireless telecommunication credit to a wireless subscriber's account. The financial transaction system may be used to handle administrative, financial, regulatory, communicative, and information management tasks associated with processing a request for a wireless telecommunication credit transfer. In an exemplary embodiment, the financial transaction system may receive a request for a wireless telecommunication credit transfer. This request may come from various entities desiring the transfer of wireless telecommunication credit. Entities capable of requesting the transfer may include, but are not limited to, the recipient (the entity receiving the wireless telecommunication credit), the funding user (the entity providing the funding for the wireless telecommunication credit), or any other entity. Upon receipt of the request, the financial transaction system may utilize a financial transaction protocol to process the request. In an exemplary embodiment of the financial transaction protocol, the financial transaction system sends a request to the funding user for authorization of the request to transfer wireless telecommunication credit. Upon receipt of an authorization from the funding user, the financial transaction system transfers a wireless telecommunication credit to the wireless telecommunication account of the recipient and charges the funding user for the wireless telecommunication credit.

In an exemplary embodiment of the present invention, the recipient may not be required to be a member or registered user of the financial transaction system. The recipient may simply be a wireless subscriber. In such an embodiment, the financial transaction system may execute a transfer of wireless telecommunication credit without having any more information about the recipient than the recipient's wireless telephone number. Thus, no pre-registration of the recipient is required to complete a transfer of wireless telecommunication credit. Furthermore, the recipient may not be required to have a financial account to receive the transfer of wireless telecommunication credit. In an exemplary embodiment, the recipient is not required to register a bank account, credit card, or any other type of financial account with the financial transaction system in order to receive a transfer of wireless telecommunication credit. The wireless telecommunication credit may be transferred directly to the recipient's wireless service provider and credited directly to the recipient's wireless telecommunication account. Additionally, the recipient need not be burdened by any other pre-registration requirements to receive transfers of wireless telecommunication credit. In a non-limiting example, the recipient is not required to have access to a computer with a connection to the Internet in order to register. Transfers may be completed based simply on the recipient's wireless telephone number.

The term wireless is used herein to describe any type of communication, transmission, or reception through the atmosphere. Wireless may refer to communication, transmission, or reception through conventional cellular networks or any other type of wireless network. The term wireless device is used herein to describe devices enabled to communicate, transmit, or receive data in a wireless network, such as a mobile phone, smart phone, PDA, handheld PC or any other device. Those of skill in the art will appreciate that the term wireless is synonymous with the term mobile. The term wireless telecommunication credit is used herein to define a unit of value associated with a wireless telecommunication subscriber's account with that subscriber's wireless telecommunications service provider. A wireless telecommunication credit may represent minutes of talk time, a specified amount of data transfer, a monetary amount, a unit of currency, or any other unit of value. The terms wireless telecommunication subscriber and wireless subscriber are used herein to define an individual or entity that uses wireless telecommunication services. The terms wireless telecommunication service provider and wireless service provider are used herein to describe a corporation or entity that provides wireless telecommunication services to wireless subscribers. Wireless telecommunication service providers are also known to those of skill in the art as carriers or telephone companies. The term wireless telecommunication account is used herein to describe a wireless subscriber's account with a wireless telecommunication service provider.

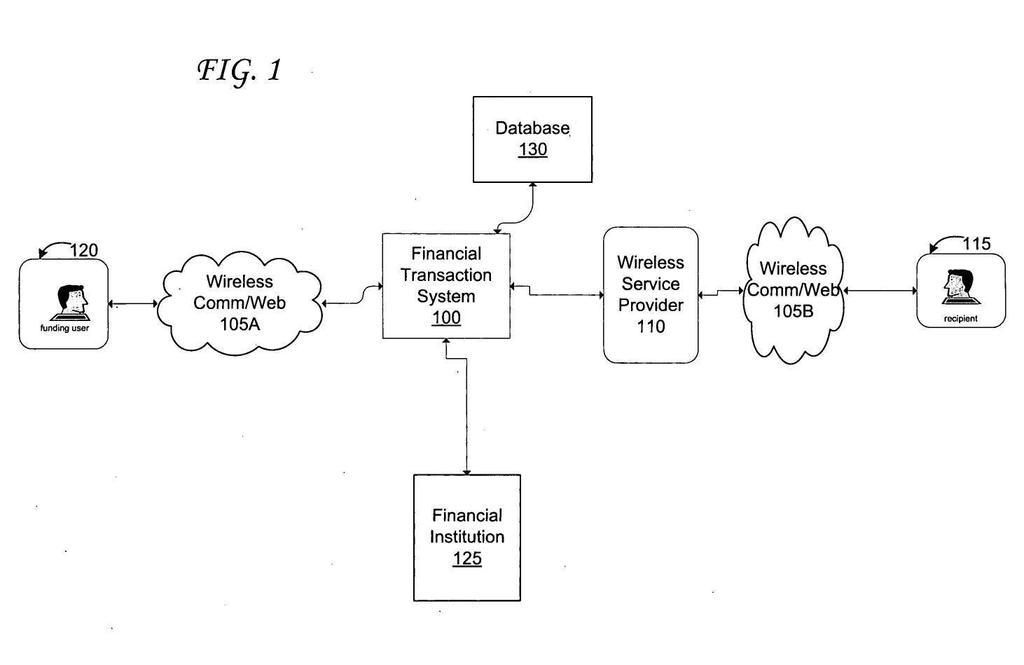

FIG. 1 provides a high level diagram of an exemplary network in which a system for adding credit to a wireless telecommunication account is implemented in accordance with one embodiment of the present invention. A financial transaction system 100 may be configured to interface with the multiple components involved in executing the financial transaction. The financial transaction system 100 may have a communication link or multiple communication links. The communication links allow the financial transaction system 100 to transmit and receive data with a variety of sources. In the exemplary embodiment depicted in FIG. 1, the financial transaction system 100 is enabled to transmit and receive data, via two wireless communication links, 105A and 105B, with a wireless service provider 110, a recipient 115, a funding user 120, and a financial institution 125. Those of skill in the art will appreciate that the network depicted in FIG. 1 is a very simplified depiction of the network in which the financial transaction system 100 may operate, as the financial transaction system 100 may be enabled to be connected to multiple wireless service providers, recipients, funding users, and financial institutions via a variety of different communication links. Additionally, the financial transaction system 100 may be connected to a wide variety of networks, servers, and/or applications which are used to carry out a financial transaction. For example, the financial transaction system 100 may be connected to networks to which a large number of recipients have access and to networks to which a large number of funding users have access. In an exemplary embodiment, the funding user 120 may be connected to a wireless telecommunication network and/or the Internet 105A. Similarly, the recipient 115 may be connected to a wireless telecommunication network and/or the Internet 105B. Additionally, the financial transaction system 100, in an exemplary embodiment, has an interface to a financial institution 125. This financial institution 125 may be any type of financial institution such as credit card agencies, banks, and internet bank providers such as Paypal, NetTeller, and others. The financial transaction system 100 may be connected to multiple financial institutions of many varieties. Furthermore, the financial transaction system 100 may have an interface to the wireless telecommunications service provider for the wireless telecommunication accounts of the recipients. In an exemplary embodiment, the financial transaction system 100 also has an interface to a database 130 that stores and maintains all data concerning the financial transactions, such as user accounts, transaction data, and wireless telecommunications service provider information. The database 130 can be any type of memory device, including a memory device capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, or RAM memory cards. In an exemplary embodiment, the database 130 may be a central database to the financial transaction system 100 that store and log all events and executions of the financial transaction system 100. The database 130 may be configured to record all data of financial transactions, such that the data can be viewed in real time. The financial transaction system 100 may provide access to the data on the database 130 via web interface, telephone based interface, or other interface access system or protocol. In an exemplary embodiment, the users of the financial transaction system 100 can log onto to the financial transaction system 100 via a web, wireless, or other interface and view data concerning that user's financial transactions over a given period. In a non-limiting example, a user may log onto the financial transaction system 100 and access the database 130 to view summary reports of financial transactions conducted by that user over a specified time period. The database 130 may provide real time data, such that users can monitor the progress of particular financial transactions.

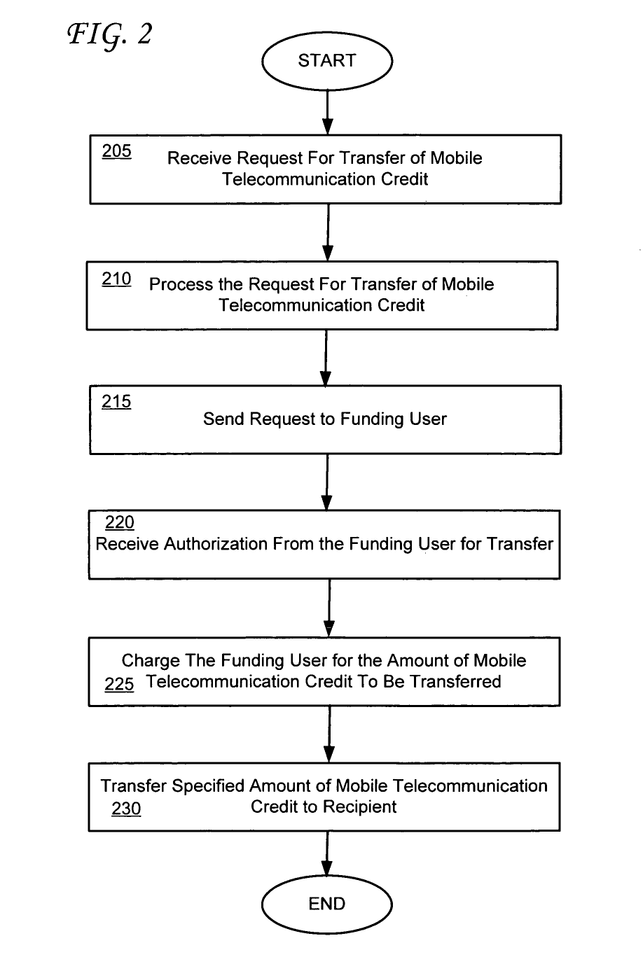

FIG. 2 provides a flow chart illustrating a method of adding credit to a wireless telecommunication account in accordance with an exemplary embodiment of the present invention. As shown in FIG. 2, a first step may include receiving a request for the transfer of wireless telecommunication credit 205. Next, the request for the transfer of wireless telecommunication credit may be processed 210. The request may then be sent to the funding user 215. Next, authorization may be received from the funding user for the transfer of specified amount of wireless telecommunication credit 220. Upon authorization, the funding user may be charged for the amount of the wireless telecommunication credit to be transferred 225. Finally, the specified amount of wireless telecommunication credit may be transferred to the recipient 230.

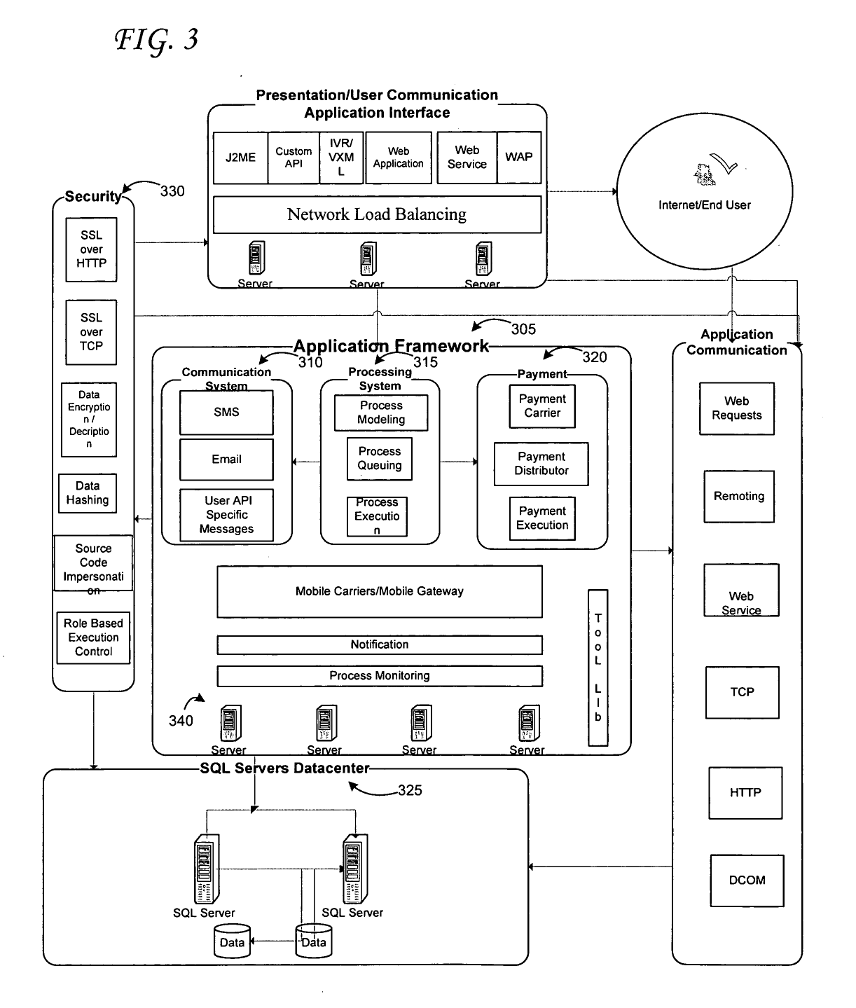

FIG. 3 is a block diagram illustrating the architecture of certain components within the financial transaction system 100 in accordance with an exemplary embodiment of the present invention. The financial transaction system 100 may include an application framework 305 that defines the interface between the various functional modules that make up the applications of the financial transaction system 100. In the non-limiting exemplary embodiment depicted in FIG. 3, the application framework has three primary application modules: communication system module 310, processing system module 315, and payment module 320. These three modules execute a number of the tasks involved in processing a request for the transfer of wireless telecommunication credit. The communication system module may be capable of receiving the request messages for wireless telecommunication credit in a variety of formats, including SMS messages, emails, voice calls, instant messages, or user API specific messages. The communication system module 310 may be capable of interfacing with the processing system module 315.

The processing system module 315 is capable of implementing the financial transaction protocol associated with a particular transaction. The processing system module 315 handles such applications as process modeling, process queuing, and process execution. Upon receipt of the request for wireless telecommunication credit from the communication system module 310, the processing system module 315 performs the steps defined by the designated financial transaction protocol. These steps may include a series of checks and executions to ensure matters such as, but not limited to, the validity of the request message, validity of the funding user's account, status of the funding user's account, status of the requests made by the recipient, authorization of the transfer, and interfacing with the communication system module 310 and the payment module 320 to carry out the transfer. For each financial transaction protocol, the processing system module 310 may have a defined methodology that it implements to execute the financial transaction. In a non-limiting example, if the protocol requires an authorization message be sent to the funding user, the processing system module 315 directs the communication system module 310 to send this message to the funding user. In another non-limiting example, if the protocol requires the funding user's account be verified, then the processing system module 315 interfaces with the payment module 320 to verify the status of the funding user's account.

The payment module 320 is the third module of the exemplary embodiment of the application framework 305 for the financial transaction system 100 depicted in FIG. 3. The payment module 320, in an exemplary embodiment, may execute instructions to interface with the entities, such as the financial institution 125 (FIG. 2), against which the wireless telecommunication credits may be assessed. In a non-limiting example, the payment module 320 may receive instructions from the processing system module 315 to charge a credit card registered with a financial institution 125 (FIG. 2) for the amount of a wireless telecommunication credit, and subsequently cause that charge to be communicated to the financial institution 125 (FIG. 2) for the credit card. In another non-limiting example, the payment module 320 may receive instructions from the processing system module 315 to debit a bank account of a financial institution 125 (FIG. 2) for the amount of a wireless telecommunication credit. The payment module 320 may also interface with a variety of different financial institutions, such as banks, internet banks, and credit card companies.

As illustrated in the exemplary embodiment depicted in FIG. 3, the application framework is supported by a server farm 340 and is capable of accessing the user data stored in a SQL Server Datacenter 325. The application framework 305 is protected by a security layer 330 responsible for verifying the security of all information received by and sent from the application framework.

Users of the financial transaction system 100 may access the application framework 305 through a variety of different interfaces. For example, and not limitation, a user may access the interface for the financial transaction system 100 via a wireless device, a web application, a web service, a Java Platform Micro Edition (J2ME) communication, a Wireless Access Protocol (WAP) communication, a Interactive Voice Response (IVR)/Voice XML (VXML) communication, Custom API communication, or other suitable communication tool or application.

The financial transaction system 100 is capable of handling requests for the transfer of wireless telecommunication credit from a wide range of sources, devices, protocols, and systems. In an exemplary embodiment, the recipient may initiate the request for wireless telecommunication credit via an SMS message. In an alternative embodiment, the recipient may initiate the request via the Internet. In another embodiment, the recipient may initiate the request via an email. In yet another embodiment, the recipient may initiate the request with an instant message. In other embodiments, the recipient may initiate the request from a wireless device via a WAP communication. Additionally, the request may be initiated via any other suitable type of communication device or system, including a request by phone, wireless device, personal data assistant (PDA), smart phone, IVR request, J2ME request, request via a Custom API, or other related device or communication. The financial transaction system 100 may also enable the funding user, or any other entity, to request the transfer of wireless telecommunication credit from a plurality of the described devices and systems.

In addition to the ability to make requests from a variety of systems or devices, the funding user may receive requests on a variety of systems or devices. In a non-limiting example, the funding user may receive a request for the transfer of wireless telecommunication credit via a wireless device, phone, personal data assistant (PDA), smart phone, email, instant message, or any other source of communication or communication device. Those of skill in the art will appreciate that the financial transaction system 100 may be configured to request for the transfer of wireless telecommunication credit without regard to the source, format, or transmission protocol of the request or authorizing communication.

The financial transaction system 100 executes requests for the transfer of wireless telecommunication credit according to a particular financial transaction protocol designated for a particular type of request. Preferably, each financial transaction protocol has a defined process through which a request is initiated, validated, and executed. The financial transaction system 100 may implement a particular financial transaction protocol for any grouping of requests, including, among others, an entire network, a subgroup of a network, a defined group of recipients or funding users, or an individual recipient or funding user. Therefore, different financial transaction protocols may be established for different segments of networks or users, according to characteristics or parameters associated with a given segment of a network or group of users.

The financial transaction system 100 may be adaptable, modifiable, and robust in order to accommodate for the wide variety of protocols, architectures, and implementations that exist in various wireless networks. The financial transactions executed by the financial transaction system 100 may be complicated and involve the execution and merger of a variety of different functions. The financial transaction system 100 may be configured with the ability to communicate across a broad spectrum of network protocols, and enabled to execute a variety of different functionality, such as financial, regulatory, communicative, and data management functionality.

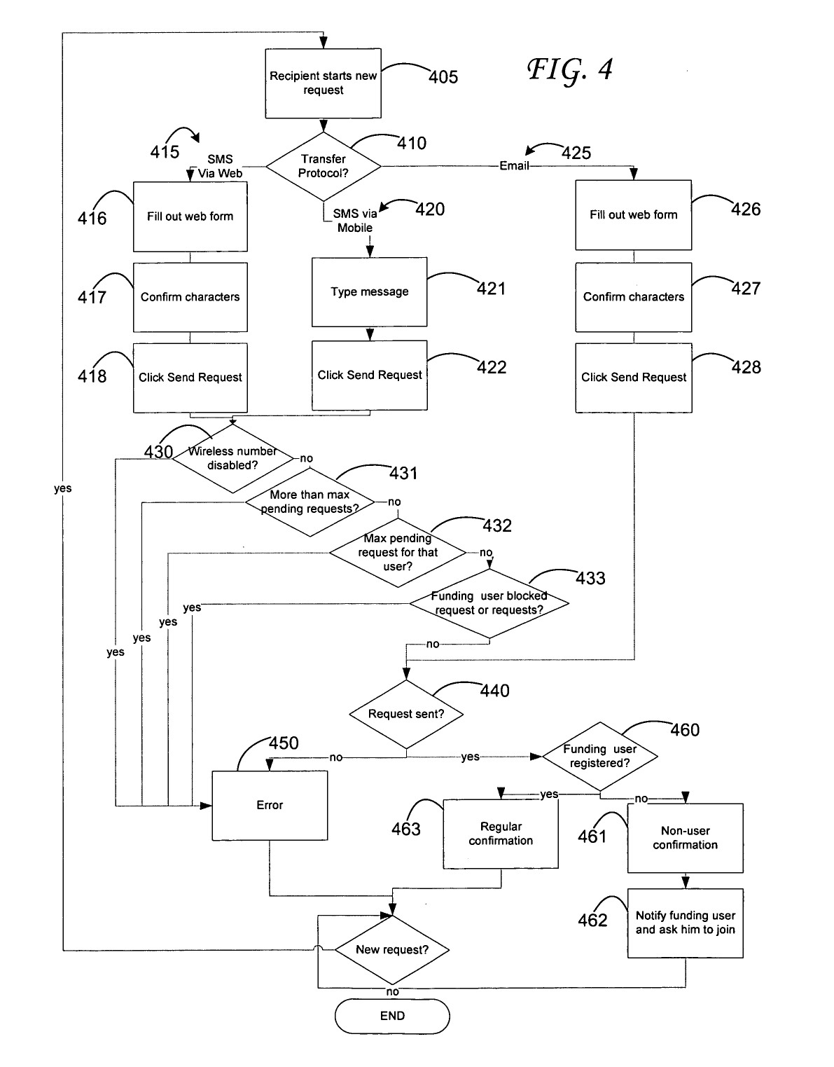

FIG. 4 is a flow chart an illustrating a financial transaction protocol in an exemplary embodiment of the present invention. Those of skill in the art will appreciate that this is simply one exemplary embodiment of a financial transaction protocol, and the protocol may be implemented in wide variety of other ways without departing from the scope of the invention. The flowchart illustrated in FIG. 4 illustrates the various decision stages of the financial transaction protocol when the recipient initiates the request for mobile telecommunication credit. Those of skill in the art will appreciate that the financial transaction system may be capable of processing requests that come not only from the recipient, but also the funding user, or even a third party or other entity.

The process illustrated in FIG. 4 begins when the recipient sends a request for wireless telecommunication credit 405. The financial transaction system 100 receives the request 405 from the recipient. The financial transaction system 100 determines the requesting protocol by which the recipient is making the request and the transfer protocol by which the recipient desires to send the request 410. The request may be initiated through a variety of different transfer protocols, such as, but not limited to, an SMS request over a wireless network, an Internet based communication, a email, IVR request, J2ME request, request via a Custom API, or other related device or communication. An Internet based communication scheme is used herein to describe communications made from an Internet interface. In a non-limiting example, an Internet based communication may be a communication made from a web page and transmitted via TCP/IP protocol via the Internet. Additionally, the request may be transmitted through a variety of different transfer protocols, such as an SMS request over a wireless network, an SMS request initiated from an Internet request, an email, or other related device or communication. In the exemplary embodiment depicted in FIG. 4, the request may be initiated by three different methods: (1) a wireless device, (2) an Internet interface, (3) an email. In the exemplary embodiment depicted in FIG. 4, the request may be transferred by three different methods: (1) from an Internet based request, via SMS, to a funding user's wireless device 415, (2) from a recipient's wireless device, via SMS, to a funding user's wireless device 420, (3) from an Internet based request via email 425.

If the financial transaction system 100 determines that the user is making the request 405 on the Internet to be sent via SMS 415, the recipient may be required to fill out a web form 416. This web form may request the parameters of the request for transfer of wireless telecommunication credit, including the wireless phone number of the funding user and the amount of wireless telecommunication credit being requested. Those of skill in the art will appreciate that this web form may have a variety of parameters depending upon the requirements of the financial transaction protocol. Next the recipient may be requested to enter confirmation characters 417 to validate the submission of the web form 416. In an exemplary embodiment, this SMS text message contains only the amount of credit required and the funding user's phone number. Once validated, the recipient may initiate the transmission 418 of the request. The request may be sent via numerous different transmission protocols to the financial transaction system 100, including, but not limited to, HyperText Transfer Protocol (HTTP), HyperText Transfer Protocol over an encrypted Secure Socket Layer (HTTPS), Simple Mail Transfer Protocol (SMPT), or Short Message Peer to Peer (SMPP).

If the financial transaction system 100 determines that the user is making the request 405 with a wireless device 420, the recipient may be requested to type a text message 421 to be sent via SMS to a funding user's wireless device. This text message 421 may include the parameters of the request for transfer of wireless telecommunication credit, including the wireless phone number of the funding user and the amount of wireless telecommunication credit being requested. Those of skill in the art will appreciate that this text message 421 may have a variety of parameters depending upon the requirements of the financial transaction protocol. Once the text message 421 is completed, the recipient may initiate the transmission 422 of the request. Similar to the Internet based request, the request may be sent via numerous different transmission protocols to the financial transaction system 100, including via SMPT and SMPP.

If the financial transaction system 100 determines that the user is making an Internet based request to be sent via email 425, the recipient may be requested to fill out a web form. This web form may include the parameters of the request for transfer of wireless telecommunication credit, including the wireless phone number of the funding user and the amount of wireless telecommunication credit being requested. Those of skill in the art will appreciate that this web form may have a variety of parameters depending upon the requirements of the financial transaction protocol. Next the recipient may be requested to enter confirmation characters 427 to validate the submission of the web form 426. Once validated, the recipient may initiate the transmission of the request 428 via an email to the funding user.

In an exemplary embodiment, the remaining financial transaction protocol procedure for both Internet based SMS requests and wireless device based SMS requests may be the same. After the recipient executes the command to send the request, the financial transaction system 100 may first validate the recipient's information, such as whether the recipient has a valid wireless telecommunication account in a network to which the financial transaction system 100 is connected. The system may then verify the syntax of the request. In an exemplary embodiment, the verification of the request syntax may be a determination of the request's adherence to a set of transaction rules, such as a proper designation of the amount of the wireless telecommunication credit requested.

Next, the financial transaction system 100 may check to see if the recipient's wireless telephone number has been disabled 430. In certain embodiments, the financial transaction protocol may provide this feature in order to enable the financial transaction system 100 to prevent requests from fraudulent entities or recipients. In other financial transaction protocols, there may be no check performed to ensure to the validity of the recipient's wireless telephone number.

Once the recipient's wireless telephone number has been verified, the financial transaction system 100 may determine whether the recipient has exceeded the maximum number of requests per time period for that individual recipient 431. In a non-limiting example, a recipient may be limited to three requests a day. If it is determined that he recipient has exceed the maximum number of requests for a given time period, then an error message 450 may be sent and the request may be aborted. The error message may be sent to the recipient via numerous different transmission protocols, including via HTTP, HTTPS, SMPT, or SMPP.

Furthermore, the financial transaction system 100 may determine whether the funding user has any pending requests outstanding 432. In an exemplary embodiment, the financial transaction protocol may only allow a funding user to have one outstanding request. In other embodiments, the funding user may have a maximum of five requests. Yet in another embodiment the user may have an unlimited number of requests. In an alternative embodiment, the financial transaction system 100 may determine whether the funding user has exceeded the maximum number of requests per time period for that individual funding user. In this embodiment, if the funding user has exceeded the maximum number of requests, then an error message 450 may be sent to the recipient to indicate that the request could not be processed.

If both the recipient and the funding user have not exceeded their maximum number of requests, then the financial transaction system 100 determines whether the funding user has placed any limitations on the given request 433. In a non-limiting example, a funding user may be permitted to block all requests from a specific geographic region, from a specific wireless telecommunications service provider, or from a particular recipient. If a block has been placed against the request, then an error message 450 is sent to the recipient indicating the request could not be processed.

If the funding user has not placed a block against the request, then the financial transaction system 100 may send the request 440 to the funding user. The financial transaction system 100 is capable of transmitting the request to the funding user via any number of different protocols and transmission networks, including HTTP, HTTPS, SMPT, and SMPP. The financial transaction system 100 may determine whether the funding user is a registered user 460 of the financial transaction system 100. If the funding user is not registered 461, then a message may be sent to the recipient to indicate that the funding user is not registered. Furthermore, a message may be sent to the funding user 462 to notify him/her that a request for wireless telecommunication credit has been made to that funding user and inviting that funding user to join the financial transaction system 100. In an exemplary embodiment, the funding user may respond to the message by joining the financial transaction system 100 service. In one non-limiting example, the funding user may join via an Internet interface. In another non-limiting example, the funding user may join via a wireless communication device. After becoming a registered user of the financial transaction system 100, the funding user, in an exemplary embodiment, may subsequently be notified of all previous requests for transfer of wireless telecommunication credit. The funding user may then respond to these requests in accordance with the remainder of the financial transaction protocol. If the funding user is registered, then the financial transaction system 100 may proceed with the financial transaction protocol for processing the funding user's authorization of the request 463.

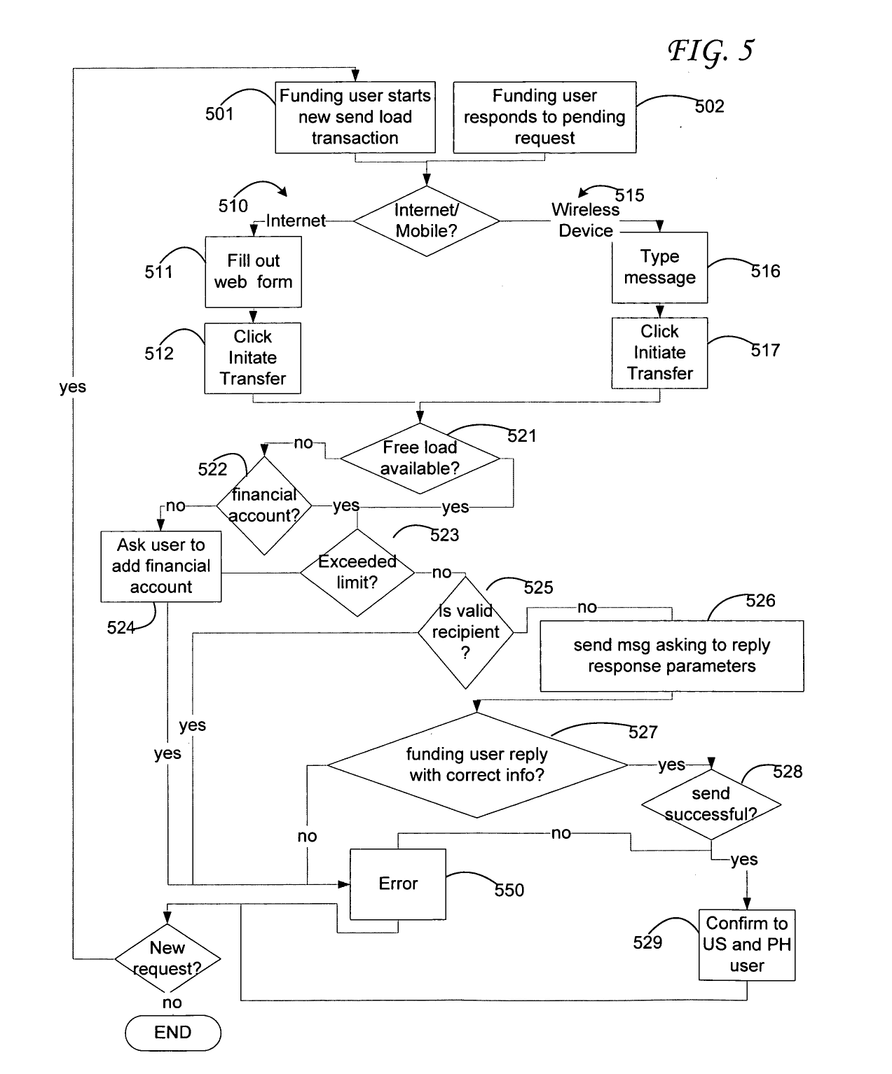

FIG. 5 is a flow diagram illustrating a financial transaction protocol from the funding user's perspective in accordance with in an exemplary embodiment of the present invention. As illustrated, the financial transaction system 100 may allow for the funding user to initiate a new financial transaction 501 or respond to a request for wireless telecommunication credit 502. In the case of the funding user initiating a new financial transaction 501, the funding user may have the ability to initiate a transfer of wireless telecommunication credit without any initial involvement by the recipient. In the case of responding to a pending request 502, the recipient has already initiated the request and the funding user is enabled to respond to that request. In an alternative embodiment, a third party has the ability to initiate the request for the transfer of wireless telecommunication credit. Therefore, an independent third party may initiate a request that a funding user transfer wireless telecommunication credit to a recipient.

The financial transaction system 100 may enable the funding user to either initiate or respond to a request for wireless telecommunication credit via a number of different transmission devices and networks. As shown in FIG. 5, the financial transaction system 100 may allow the funding user to initiates/respond via the Internet 510 or transmission from a wireless device 515. If the funding user initiate/responds via the Internet 510, then the financial transaction system 100 may request the user to fill out a web form. This web form may request the parameters of the request for transfer of wireless telecommunication credit, including the wireless phone number of the recipient and the amount of wireless telecommunication credit to be transferred. Once the web form 511 is complete, the funding user may cause the transfer to be initiated 512. The initiate transfer message 512 may be sent to the financial transaction system 100 via numerous different transmission protocols to the financial transaction system 100, including, but not limited to, HTTP, HTTPS, SMPT, or SMPP. In an exemplary embodiment, the initiate transfer message 512 may be sent via HTTP to the financial transaction system 100 from an Internet connection by the funding user.

Alternatively, a funding user may initiate or respond via a wireless device 515. The funding user may respond to a request or initiate a transfer by typing a message 516 into the funding user's wireless device. This message may include the parameters of the request for transfer of wireless telecommunication credit, including the wireless phone number of the recipient and the amount of wireless telecommunication credit to be transferred. Once the message 516 is complete, the funding user may cause the transfer to be initiated 517. The initiate transfer message 517 may be sent to the financial transaction system 100 via numerous different transmission protocols to the financial transaction system 100, including via HTTP, HTTPS, SMPT, SMPP. In an exemplary embodiment, the initiate transfer message 517 may be an SMS message sent to the financial transaction system 100 from the wireless device of the funding user.

Once the funding user has initiated the transfer 512/517, the financial transaction system 100 determines whether the funding user has free credit available 521. If the funding user does not have any free credit, then a determination is made as to whether a financial account is on file 522 for the individual funding user. The financial account may be any variety of financial accounts, including, but not limited to, a credit card, bank account, e-wallet, or internet bank account such as NetTeller or Paypal. If the funding user does not have a valid financial account, then the financial transaction system 100 may send a request to the funding user to register a financial account 524.

If the funding user's financial account is on file or if the funding user has free credit available, the financial transaction system may determine whether the financial account is still under its limit for the maximum number of transactions within a given time period 523. If the financial account is over the maximum, then an appropriate error message 550 may be sent to the funding user.

If the financial transaction system 100 determines that the funding user is within the funding user's limit for the maximum number of transactions within a given time period 523, then the financial transaction system 100 may determine whether the recipient's wireless phone number has been disabled 525. In certain embodiments, the financial transaction protocol may provide this feature in order to enable the financial transaction system 100 to prevent requests from fraudulent entities or recipients. In other financial transaction protocols, there may be no check performed to ensure to the validity of the recipient's wireless telephone number.

If the recipient's wireless phone number has not been disabled, then a message may be sent to the funding user requesting the user to reply to the request with a set of response parameters 526. In an exemplary embodiment, this authorization process 526 may only be required if the funding user is executing the transfer from the funding user's wireless device, as the authorization information may be included in the Internet form. The funding user may have the option to accept or decline the request. If the funding user accepts, then the funding user may reply to the financial transaction system 100 with a set of response parameters. In an exemplary embodiment, the response parameters may include a credit amount, a pin, and a transaction ID. After sending the message to the funding user, the financial transaction system 100 may wait for a response for a given time period. If the funding user does not respond within a given time period, a error message 550 may be sent to the funding user.

Upon receipt of a response from the funding user, the financial transaction system 100 may validate the contents of the response 527. In one embodiment, the financial transaction system 100 analyzes the pin provided in the response and determines whether the pin provided by the funding user matches the pin stored in the financial transaction system 100. In another embodiment, no pin is required. If the funding user's response is properly verified, then the financial transaction system 100 executes a transfer of wireless telecommunication credit in the amount specified by the funding user. In an exemplary embodiment, the financial transaction system 100 may execute the transfer by communicating with the wireless service provider of the recipient and causing a credit of the amount verified to be applied to the wireless telecommunication account of the recipient. Furthermore, a charge in the amount of the credit transferred may be assessed against the financial account of the funding user. In the event that the funding user was utilizing free credit, then the funding user's free credit amount may be debited in the amount of the credit transferred.

Upon successfully completing the transfer of the wireless telecommunication credit, the financial transaction system 100 may send a confirmation message to the recipient 529 indicating that the desired amount of wireless telecommunication credit has been successfully transferred. The financial transaction system 100 may also send a confirmation message to the funding user 529 indicating that the desired amount of wireless telecommunication credit has been successfully transferred.

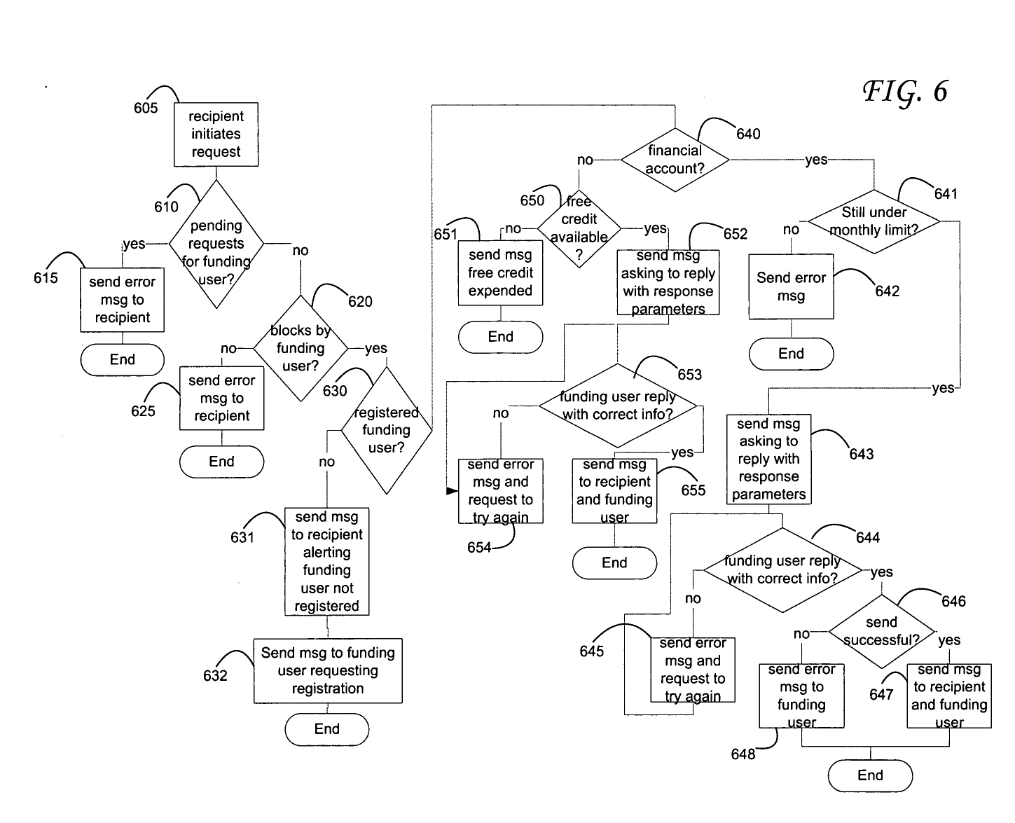

FIG. 6 is a flow diagram illustrating a financial transaction protocol in an exemplary embodiment of the present invention. Those of skill in the art will appreciate that this is simply one exemplary embodiment of a financial transaction protocol, and the protocol could be implemented in wide variety of other ways without departing from the scope of the invention. The flowchart illustrated in FIG. 6 illustrates the various decision stages of the financial transaction protocol when the recipient initiates the request for mobile telecommunication credit. Those of skill in the art will appreciate that the financial transaction system may be capable of processing requests that come not only from the recipient, but also the funding user, or even a third party or other entity.

The process illustrated in FIG. 6 begins when the recipient sends a request for mobile telecommunication credit 605. The financial transaction system receives the request from the recipient. The system first validates the recipient's information, such as whether the recipient has a valid mobile account in a network to which the financial transaction system is connected. The system then verifies the syntax of the request. In an exemplary embodiment, the verification of the request syntax may be a determination of the request's adherence to a set of transaction rules, such as a proper designation of the amount of the mobile telecommunication credit requested.

Once the request has been verified, the financial transaction system determines whether the recipient has exceeded the maximum number of requests per time period for that individual recipient. In a non-limiting example, a recipient may be limited to three requests per day. Furthermore, the system determines whether the funding user has exceeded the maximum number of requests per time period for that individual funding user 610. If either the recipient or the funding user has exceeded the maximum number of requests 610, then an error message 615 may be sent to the recipient to indicate that the request could not be processed.

If both the recipient and the funding user have not exceeded their maximum number of requests, then the financial transaction system determines whether the funding user has placed any limitations on the given request 620. In a non-limiting example, a funding user may be permitted to block all requests from a specific geographic region, from a specific wireless telecommunications service provider, or from a particular recipient. If a block has been placed against the request, then an error message may be sent to the recipient indicating the request could not be processed 625.

If the funding user has not placed a block against the request, then the financial transaction system may determine whether the funding user is a registered user of the financial transaction system. If the funding user is not registered, then a message may be sent to the recipient to indicate that the funding user is not registered 631. Furthermore, a message may be sent to the funding user to notify him/her that a request for mobile telecommunication credit has been made to that funding user and inviting the funding user to join the financial transaction system 632. In an exemplary embodiment, the funding user may respond to the message by joining the financial transaction system service. In one non-limiting example, the funding user may join via an Internet interface. In another non-limiting example, the funding user may join via a wireless communication device. After becoming a registered user of the financial transaction system, the funding user, in an exemplary embodiment, subsequently be notified of all previous requests for transfer of mobile telecommunication credit. The funding user may then respond to these requests in accordance with the remainder of the financial transaction protocol.

If the funding user is determined to be a registered and valid user of the financial transaction system, then a determination is made as to whether a financial account is on file for the individual funding user 640. The financial account may be any variety of financial accounts, including a credit card, bank account, e-wallet, or internet bank account such as NetTeller or Paypal. If the funding user's financial account is on file, the system determines whether the financial account is still under its limit for the maximum number of transactions within a given time period 641. If the financial account is over the maximum, then an appropriate error message may be sent to the funding user 642.

If the financial account is under its limit, then a message may be sent to the funding user requesting the user to reply to the request with a set of response parameters 643. The funding user has the option to accept or decline the request. If the funding user accepts, then the funding user may reply to the financial transaction system with a set of response parameters 644. In an exemplary embodiment, the response parameters may include a credit amount, a pin, and a transaction ID. The credit amount is the amount of credit for which the funding user is willing to pay. The pin may be an authorization and verification measure. The transaction ID may be a numerical identifier of the particular request made by the recipient. In an alternative embodiment, the response parameters simply include a positive authorization by the funding user. In another embodiment, the funding user may simply respond with a numerical value. This numerical value is the amount of mobile telecommunication credit to be transferred and serves as the funding user's authorization. After sending the message to the funding user, the financial transaction system waits for a response for a given time period. If the funding user does not respond within a given time period, a repeat message is sent to the funding user 645.

Upon receipt of a response from the funding user, the financial transaction system may validate the contents of the response. In one embodiment, the financial transaction system analyzes the pin provided in the response and determines whether the pin provided by the funding user matches the pin stored in the financial transaction system. In another embodiment, no pin is required. If the funding user's response is properly verified, then the financial transaction system executes a transfer of mobile telecommunication credit in the amount specified by the funding user to the recipient associated with the transaction ID of the request. In an exemplary embodiment, the financial transaction system may execute the transfer by communicating with the wireless telecommunications service provider of the recipient and causing a credit of the amount verified to be applied to the wireless telecommunication account of the recipient. Furthermore, a charge in the amount of the credit transferred is assessed against the financial account of the funding user. If the financial transaction system 100 determines that the wireless telecommunication credit was successfully transferred 646, then the financial transaction system 100 may send a message to the funding user and recipient confirming the successful transfer 647. If the financial transaction system 100 determines that the wireless telecommunication credit was not successfully transferred 646, then the financial transaction system 100 may send a message to the funding user requesting the funding user to resend the authorizing response 648.

In the event that a credit card is not on file, the financial transaction system may determine whether the funding user has free credit available 650. If the funding user does not have any free credit, then an error message may be sent to the funding user indicating that the funding user's free trial is over 651. If the financial transaction system determines that the funding user has available free credit with the financial transaction system, then a message is sent to the funding user requesting the user to reply to the request with a set of response parameters 652. The funding user has the option to accept or decline the request. If the funding user accepts, then the funding user should reply to the financial transaction system with a set of response parameters 653. In an exemplary embodiment, the response parameters include a credit amount, a pin, and a transaction ID. After sending the message to the funding user, the financial transaction system waits for response for a predetermined time period. If the funding user does not respond within the predetermined time period, a repeat message may be sent to the funding user 654.

Upon receipt of a response from the funding user, the financial transaction system validates the contents of the response. In one embodiment, the financial transaction system analyzes the pin provided in the response and determines whether the pin provided by the funding user matches the pin stored in the financial transaction system. In another embodiment, no pin is required. If the funding user's response is properly verified, then the financial transaction system executes a transfer of mobile telecommunication credit in the amount specified by the funding user to the recipient associated with the transaction ID of the request. In an exemplary embodiment, the financial transaction system may execute the transfer by communicating with the wireless telecommunications service provider of the recipient and causing a credit of the amount verified to be applied to the wireless telecommunication account of the recipient. Furthermore, the funding user's free credit may be debited in the amount of the credit transferred. If the financial transaction system 100 determines that the wireless telecommunication credit was successfully transferred, then the financial transaction system 100 may send a message to the funding user and recipient confirming the successful transfer 655.

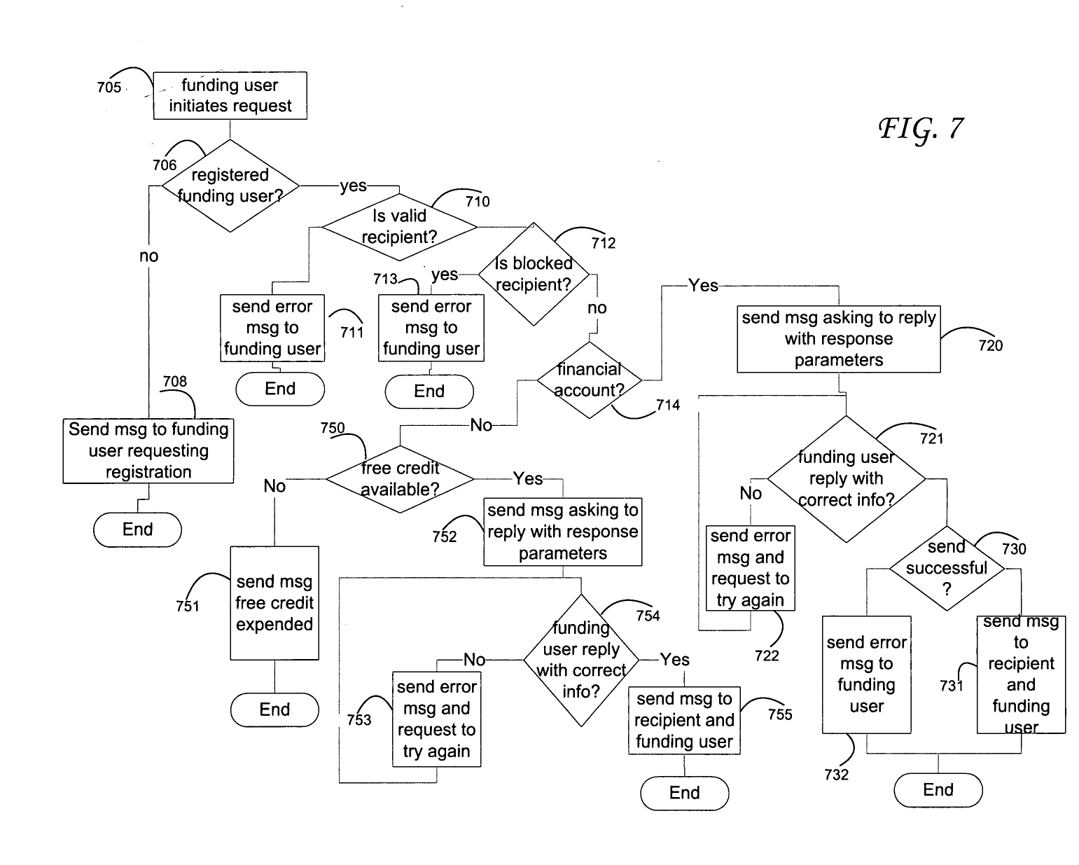

FIG. 7 is a flow diagram illustrating another financial transaction protocol in accordance with an exemplary embodiment of the present invention. The flowchart illustrated in FIG. 7 illustrates the various decision stages of the financial transaction protocol when the funding user initiates the request for mobile telecommunication credit. As previously provided, the financial transaction system may be capable of processing requests that come from not only the funding user, but also the recipient, or even a third party or other entity.

The process illustrated in FIG. 7 may begin when the funding user sends a request for a wireless telecommunication credit transfer 705. The financial transaction system receives the request from the funding user. The system may then verify that the syntax of the request is correct. The verification of the request syntax may be a determination of the request's adherence to a set of transaction rules, such as a proper designation of the amount of the mobile telecommunication credit.

Once the request has been verified, then the financial transaction system determines whether the funding user is a registered user of the financial transaction system 706. If the funding user is not registered, then a message may be sent to the funding user to invite the funding user to join the financial transaction system service 708. In an exemplary embodiment, the funding user may respond to the message by joining the financial transaction system service. In one non-limiting example, the funding user may join via an Internet interface. In another non-limiting example, the funding user may join via a wireless telecommunication device. After becoming a registered user of the financial transaction system, the funding user, in an exemplary embodiment, will subsequently be notified of all previous requests for transfer of mobile telecommunication credit. The funding user may command that these previous requests be processed by the financial transaction system.

If the funding user is determined to be a registered and valid user of the financial transaction system, then a determination is made as to whether the recipient is a valid recipient 710. In an exemplary embodiment, the recipient is not required to be a registered user of the financial transaction system, but the recipient should be a subscriber of a wireless telecommunication network to which the financial transaction system is connected. In a non-limiting example, the only requirement for the request is that the mobile telephone number of the recipient be a valid mobile telephone number in the network of a wireless service provider supported by the financial transaction system. If the recipient is not a valid recipient, then the financial transaction system may send a message to the funding user that the request cannot be processed 711. If the recipient is a valid recipient, then financial transaction system determines whether any limitations have been placed on this recipient 712. In a non-limiting example, the funding user may have blocked transfers to certain regions and the recipient is located within the blocked region. If a block has been placed against transfer to the recipient, then an error message may be sent to the funding user 713.

If the financial transaction system determines that no limitations have been placed on the recipient, then the financial transaction system may determine whether a financial account is on file for the funding user 714. The financial account may be any variety of financial accounts, including a credit card, bank account, e-wallet, or internet bank account such as NetTeller or Paypal. If the funding user's financial account is on file, the system may determine whether the financial account is still under its limit for the maximum number of transactions within a given time period. If the financial account is over the maximum, then an appropriate error message may be sent to the funding user.

If the financial account is under its limit, then a message may be sent to the funding user requesting the user to reply to the request with a set of response parameters 720. The funding user has the option to accept or decline the request. If the funding user accepts, then the funding user should reply to the financial transaction system with a set of response parameters 721. In an exemplary embodiment, the response parameters include a credit amount, a pin, and a transaction ID. The credit amount is the amount of credit for which the funding user wishes to transfer to the recipient. The pin may be an authorization and verification measure. The transaction ID may be a numerical identifier of the particular request made by the funding user. In an alternative embodiment, the response parameters may simply include a positive authorization by the funding user. After sending the message to the funding user, the financial transaction system waits for a response for a given time period. If the funding user does not respond within the given time period, a repeat message may be sent to the funding user 722.

Upon receipt of a response from the funding user, the financial transaction system validates the contents of the response. In an exemplary embodiment, the financial transaction system analyzes the pin provided in the response and determines whether the pin provided by the funding user matches the pin stored in the financial transaction system. If the funding user's response is properly verified, then the financial transaction system executes a transfer of mobile telecommunication credit in the amount specified by the funding user to the requested recipient. In an exemplary embodiment, the financial transaction system may execute the transfer by communicating with the wireless telecommunications service provider of the recipient and causing a credit in the amount verified to be applied to the wireless telecommunication account of the recipient. Furthermore, a charge in the amount of the credit transferred may be assessed against the financial account of the funding user. If the financial transaction system 100 determines that the wireless telecommunication credit was successfully transferred, then the financial transaction system 100 may send a message to the funding user and recipient confirming the successful transfer 731. If the financial transaction system 100 determines the wireless telecommunication credit was not successfully sent, then an error message is sent 732.

In the event that a financial account is not on file, the system determines whether the funding user has free credit available 750. If the funding user does not have any free credit, then an error message is sent to the funding user indicating that the funding user's free trial is over 751. If the financial transaction system determines that the funding user has available free credit with the financial transaction system, then a message is sent to the funding user requesting the user to reply to the request with a set of response parameters 752. The funding user has the option to accept or decline the request. If the funding user accepts, then the funding user may reply to the financial transaction system with a set of response parameters. In an exemplary embodiment, the response parameters may include a credit amount, a pin, and a transaction ID. After sending the message to the funding user, the financial transaction system waits for response for a given time period. If the funding user does not respond within a given time period, a repeat message may be sent to the funding user 753.

Upon receipt of a response from the funding user, the financial transaction system validates the contents of the response 754. In an exemplary embodiment, the financial transaction system analyzes the pin provided in the response and determines whether the pin provided by the funding user matches the pin stored in the financial transaction system. If the funding user's response is properly verified, then the financial transaction system executes a transfer of mobile telecommunication credit in the amount specified by the funding user to the requested recipient. In an exemplary embodiment, the financial transaction system may execute the transfer by communicating with the wireless telecommunications service provider of the recipient and causing a credit of the amount verified to be applied to the wireless telecommunication account of the recipient. Furthermore, the funding user's free credit may be debited in the amount of the credit transferred. If the financial transaction system 100 determines that the wireless telecommunication credit was successfully transferred, then the financial transaction system 100 may send a message to the funding user and recipient confirming the successful transfer 755.

In addition to the financial transaction protocols defined above in relation to FIGS. 4-7, the financial transaction system 100 is capable of implementing a large variety of different financial transaction protocols. Those of skill in the art will appreciate that the financial transaction protocol could be constructed in a variety of different ways according to desired security levels, administrative requirements, and procedures, without departing from the scope of the invention. For example, a low security financial transaction protocol could be implemented by the financial transaction system 100 in which authorization by the funding user could be simply an “accept” response from the funding user. In another non-limiting example, a high security financial transaction protocol could be implemented in which the financial transaction system 100 requires two separate and verified responses containing security pin identifiers to be sent by the funding user. The administrator of the financial transaction system 100 may construct the financial transaction protocol to meet the demands of the network and its users.

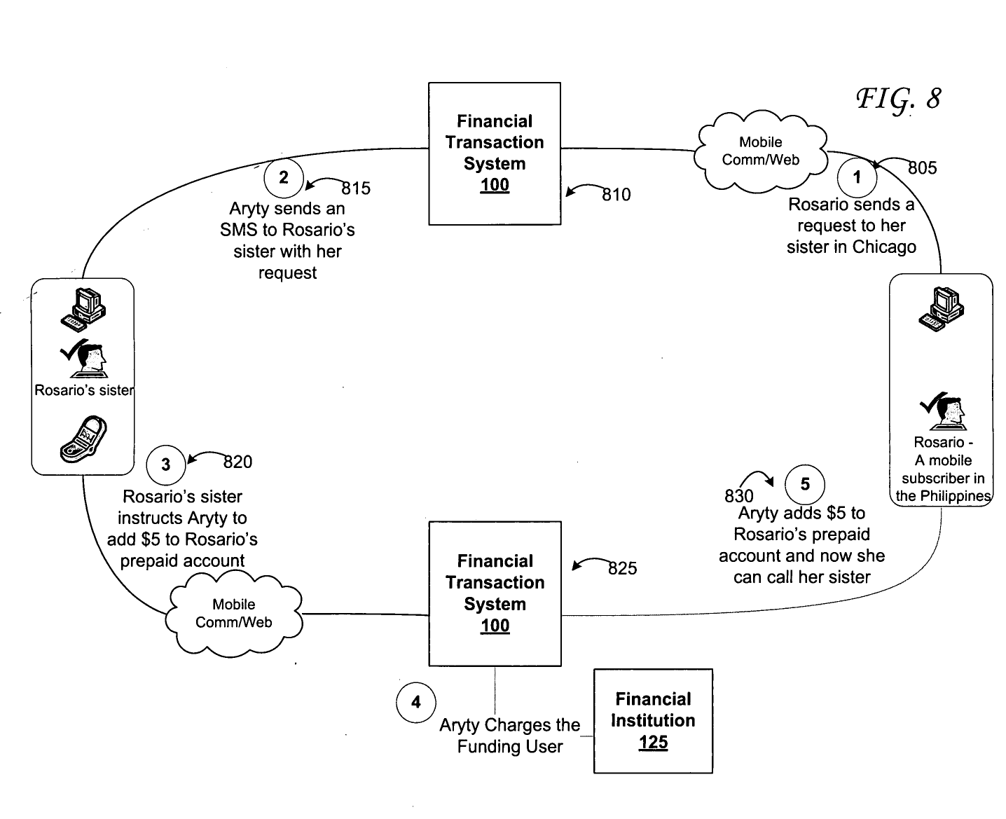

FIG. 8 is a diagram illustrating of an implementation of the financial transaction system in accordance with one embodiment of the present invention. The embodiment of the financial transaction system 100 shown in FIG. 8 provides a specific non-limiting example of a transfer made possible by the financial transaction system 100. In the embodiment depicted in FIG. 8, the recipient Rosario, a wireless telecommunications subscriber in the Philippines, sends a request for a wireless telecommunication credit to the funding user, her sister in Chicago, Ill. 805. Rosario's request is received 810 by the financial transaction system 100. The financial transaction system 100 then sends an SMS text message containing Rosario's request to the funding user in Chicago 815. The funding user receives the SMS containing Rosario's request and authorizes the financial transaction system 100 to provide a certain amount of wireless telecommunication credit to the recipient Rosario 820. The financial transaction system 100 communicate with the financial institution 125 and charge the financial account of the funding user for the amount of the wireless telecommunication credit authorized by the funding user 825. The financial transaction system 100 transfers the wireless telecommunication credit to the recipient 830.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

What is claimed is:

1. A system for adding credit to a wireless telecommunications account of a recipient, comprising:
a communication device for receiving, via a communication link, a request to transfer a wireless telecommunication credit to the wireless telecommunication account of the recipient;
a processing device, coupled to the communication device, for processing the request to transfer a wireless telecommunication credit to the wireless telecommunication account of the recipient, and directing a wireless service provider to add wireless telecommunication credit to the wireless telecommunication account.

2. The system for adding credit to a wireless telecommunications account of claim 1, wherein the processing device is further adapted to generate an authorization message and direct the communication device to send the authorization message to a funding user.

3. The system for adding credit to a wireless telecommunications account of claim 2, wherein the communication device is further adapted to receive the authorization message from the funding user.

4. The system for adding credit to a wireless telecommunications account of claim 3 wherein the authorization message from the funding user to transfer the wireless telecommunication credit comprises at least one response parameter.

5. The system for adding credit to a wireless telecommunications account of claim 3, wherein the processing device is further adapted to generate a charge to a financial account of the funding user and direct the communication device to send the charge to a financial institution.

6. The system for adding credit to a wireless telecommunications account of claim 3 wherein the authorization message from the funding user to transfer the wireless telecommunication credit is contained in at least one SMS text message.

7. The system for adding credit to a wireless telecommunications account of claim 3 wherein the authorization message from the funding user to transfer the wireless telecommunication credit is contained in at least one email.

8. The system for adding credit to a wireless telecommunications account of claim 1 wherein the wireless telecommunication credit is transferred directly to the wireless telecommunications service provider.

9. The system for adding credit to a wireless telecommunications account of claim 1 wherein the communication device receives an SMS text message via the at least one communication link containing the request from the recipient.

10. The system for adding credit to a wireless telecommunications account of claim 1 wherein the communication device receives an Internet based communication via the at least one communication link containing the request from the recipient.

11. The system for adding credit to a wireless telecommunications account of claim 1 wherein the communication device receives an email via the at least one communication link containing the request from the recipient.

12. The system for adding credit to a wireless telecommunications account of claim 1 wherein the at least one communication link is an Internet connection.

13. A method for adding credit to a wireless telecommunications account, comprising the steps of:
receiving a request for the transfer of a wireless telecommunication credit to a recipient;
processing the request for the transfer of the wireless telecommunication credit;
receiving an authorization from a funding user to transfer the wireless telecommunication credit;
charging the funding user for the wireless telecommunication credit to be transferred; and
transferring the wireless telecommunication credit to the wireless telecommunications account of the recipient.

14. The method for adding credit to a wireless telecommunications account of claim 13 wherein the wireless telecommunication credit is transferred directly to the wireless telecommunications service provider.

15. The method for adding credit to a wireless telecommunications account of claim 13 further comprising the step of the recipient initiating the request for the transfer of the wireless telecommunication credit.

16. The method for adding credit to a wireless telecommunications account of claim 15 wherein recipient initiates the request by sending an SMS text message.

17. The method for adding credit to a wireless telecommunications account of claim 15 wherein recipient initiates the request by sending an email.

18. The method for adding credit to a wireless telecommunications account of claim 15 wherein recipient initiates the request by sending an Internet based communication.

19. The method for adding credit to a wireless telecommunications account of claim 13 wherein the step of processing the request for the transfer of wireless telecommunication credit further comprises the step of sending the request to a funding user.

20. The method for adding credit to a wireless telecommunications account of claim 13 further comprising the step of the funding user initiating the request for the transfer of the wireless telecommunication credit.

21. The method for adding credit to a wireless telecommunications account of claim 20 wherein funding user initiates the request by sending an SMS text message.

22. The method for adding credit to a wireless telecommunications account of claim 20 wherein funding user initiates the request by sending an email.

23. The method for adding credit to a wireless telecommunications account of claim 20 wherein funding user initiates the request by sending an Internet based communication.

24. The method for adding credit to a wireless telecommunications account of claim 13, wherein the step of receiving an authorization to transfer the wireless telecommunication credit from a funding user comprises receiving a message containing at least one response parameter from the funding user.

25. The method for adding credit to a wireless telecommunications account of claim 13, wherein the step of receiving an authorization to transfer the wireless telecommunication credit from a funding user comprises receiving an SMS text message from the funding user.

26. The method for adding credit to a wireless telecommunications account of claim 13 further comprising the step of validating the authorization to transfer the wireless telecommunication credit from a funding user.

27. The method for adding credit to a wireless telecommunications account of claim 26 wherein the step of validating comprises a comparison of at least one response parameter provided by the funding user to at least one stored value.

28. A method for adding credit to a wireless telecommunications account, comprising the steps of:
receiving a request from a recipient for a wireless telecommunication credit;
processing the request from the recipient for the wireless telecommunication credit;
sending the request to a funding user;
receiving an authorization to transfer the wireless telecommunication credit from the funding user;
charging the funding user for the wireless telecommunication credit to be transferred; and
transferring the wireless telecommunication credit to the wireless telecommunication account of the recipient.
